(19) United States
(12) Patent Application Publication
(10) Pub. No.: US 2007/0283722 A1
(43) Pub. Date: Dec. 13, 2007

(54) Apparatus and method for drawing an optical fiber having reduced and low attenuation loss, and optical fiber produced therefrom

(76) Inventors: Abhijit Prabhakar Pathak, Aurangabad (IN); Sarvanan Guru, Aurangabad (IN); Anant Arjun Rawale, Tal-Rahuri (IN)

Correspondence Address: DAVID B. TINGEY;KIRTON & McCONKIE, Suite 1800, 60 East South Temple, Salt Lake City, UT, 84111, US

(21) Appl. No.: 11/821,947

(22) Filed: Jun. 25, 2007

(30) Foreign Application Priority Data
Jan. 29, 2007 (IN) 166/MUM/2007

(51) Int. Cl. C03B 37/02; C03B 37/025; C03B 3/00

(52) U.S. Cl. 65/500; 65/537; 65/540

(57) ABSTRACT

An apparatus and method for drawing an optical fiber having reduced and low attenuation loss, and good strength are provided. The apparatus comprises a furnace comprising a furnace chamber provided with heating means having heating elements, wherein a preform is suitably suspended in core tube of the furnace so that its tip can be suitably heated to a temperature suitable for drawing a fiber, the top face of furnace chamber is provided with a diffuser having an orifice for pumping inert gas into core tube of furnace chamber so as to maintain positive pressure inside the core tube; an opening suitable for insertion of preform; a felt capable of sealing a gap between said preform and said diffuser so as to avoid entry of atmospheric gases in core tube of furnace chamber and allowing preform with variations in its diameter to enter core tube of furnace chamber; a diffuser plate on its top surface with aims for covering said felt from top and minimizing its contact with the atmospheric gases; characterized in that top end of preform is provided with a tubular member which is an opaque glass tube non-permeable to infrared [IR] radiations generated during heating of preform inside the core tube of furnace chamber and capable of stopping passing of IR radiations therethrough to said felt to avoid local elevation of temperature at joint between handle and optical fiber preform so as to avoid burning of felt provided at diffuser, and hence to avoid formation of gap between said felt and said tube, and creation of cavity in top part of said core tube of said furnace chamber.

### BACKGROUND OF THE INVENTION

1. Related Applications

This application claims foreign priority benefits under 35 USC 119 to Indian Patent Application No. 166/MUM/2007 filed 29 Jan. 2007, entitled APPARATUS AND METHOD FOR DRAWING AN OPTICAL FIBER HAVING REDUCED AND LOW ATTENUATION LOSS, AND OPTICAL FIBER PRODUCED THEREFROM.

2. Field of the Invention

The present invention relates to an apparatus and method for drawing an optical fiber. Particularly, the present invention relates to an apparatus and method for drawing an optical fiber having reduced and low attenuation loss. Even more particularly, the present invention relates to an apparatus and method for drawing an optical fiber wherein exposure of preform, fiber and furnace to atmospheric gases and gas turbulences are avoided. The present invention also relates to an optical fiber having reduced and low attenuation loss.

3. Background and Related Art

Optical fibers are inherently versatile as a transmission medium for all forms of information, be it voice, video or data. Optical fiber comprises a core, to which essentially the entire signal is confined, and a clad surrounding the core. The optical fiber is manufactured in a way to have core with higher refractive index in order to achieve light transmission inside the core region. The optical power also spreads in the cladding region near the core region.

The optical fibers [hereinafter may be referred to as fiber] for telecommunication are required to operate with desired waveguide parameters, for example cut-off wavelength, chromatic dispersion and modified field diameter [MFD]. As the requirement for optical performance of optical fibers is stringent, the desired waveguide parameters in optical fiber needs to be properly controlled and maintained at a desired value or within desired range. However, certain physical and chemical constraints in the process for drawing the fiber from an optical fiber preform [hereinafter may be referred to as preform] can result in change in desired values of waveguide parameters of the fiber.

In-addition to above waveguide parameters, the fibers are also required to have low optical attenuation loss so as to achieve primary object of telecommunication industry, that is to transmit greater amount of information, over longer distances, in shorter period of time.

It has been observed that during drawing of a fiber when top end and/or handle portion of preform enters the furnace a gap is created between the felt and top end and/or handle portion of preform, and a cavity is formed in top portion of core tube of furnace chamber.

It has also been observed that this gap created between felt and top end and/or handle portion of preform allows free entry of atmospheric gases which causes oxidation of heating elements resulting in damage of heating capacity of heating elements and formation of oxidation products which contaminates preform and fiber being produced therefrom. The contaminated fiber has been found to have increased attenuation loss meaning thereby has been found to be unfit for desired applications and deteriorated strength meaning thereby has been found to be unfit for cabling and handling.

It has been further observed that the cavity formed in top portion of core tube of furnace chamber causes gas turbulences when top end and/or handle portion of preform enters core tube of the furnace, which in-turn causes pressure variations inside the core tube of furnace which results in diameter variations of the fiber being drawn which has been observed to have further increased attenuation loss. The pressure variations inside the core tube of furnace additionally cause curl failure of the fiber being drawn which has been found to be responsible for troubles when a fiber is spliced [joined] to other fibers and loss of overall performance of fiber in optical telecommunication system.

Therefore, if entry of atmospheric gases inside the core tube of furnace and exposure of preform and fiber being drawn therefrom and furnace elements to the atmospheric gases which enter the furnace due to formation of gap between felt and top end and/or handle portion of preform, and gas turbulences due to formation of cavity in the top part of core tube of furnace can be avoided, or alternatively, if formation of gap between felt and top end and/or handle portion of preform which is responsible for free entry of atmospheric gases inside the core tube of furnace and creation of cavity in top part of core tube of furnace chamber which is responsible for causing gas turbulences can be avoided, then not only oxidation of graphite element and damage of its heating capability can be avoided to achieve longer life of heating elements of the furnace, but contamination of preform and fiber being produced therefrom can also be avoided to have a fiber having reduced and low attenuation loss so as to have a fiber suitable for desired applications and having good strength so as to have a fiber suitable for cabling and handling. Further, the pressure variations inside the core tube of furnace can also be avoided meaning thereby unexpected diameter variations of the fiber being drawn, and hence further increase in attenuation loss of fiber, and curl failure of the fiber being drawn, and hence troubles in splicing [joining] of fiber produced to other fibers and loss of overall performance of fiber in optical telecommunication system can also be avoided. Accordingly, the fiber produced will be suitable for use in desired applications with desired performance.

This problem is better understood when referring to accompanying FIG. 1. In accordance with known prior art, the furnace 1 comprising a furnace chamber 2 provided with heating means 3 having heating elements 4 made of carbon/graphite is provided with a preform 5 having a bottom end 6 and a top end 7. The preform 5 is suitably suspended from a suspension means 8 with the help of a handle rod 9 in a manner that its bottom end 6 suitably coincides with center of the heating means 3 so that the preform tip 10 can be suitably heated to a temperature suitable for drawing a fiber 11.

The top face 12 of furnace chamber 2 is provided with a diffuser 13 having an orifice 14 on its inner side for pumping inert gas into core tube 15 of the furnace chamber 2. The diffuser 13 has an opening 17 suitable for insertion of preform and is provided with a felt 18 made of carbon/graphite fiber, which being flexible and porous in nature is capable of allowing preform with variations in its diameter to enter core tube of furnace chamber. The diffuser 13 is also provided with a top cover [may also be referred as diffuser plate] 16 on its top end with aims for covering the felt 18 from top and minimizing its contact with the atmospheric gases to avoid its oxidation. The felt 18 is capable of sealing a gap between the preform 5 and diffuser 13, because opening 17 of diffuser 13 has greater diameter than diameter of preform 5. The sealing created by felt 18 avoids entry of atmospheric gases in core tube 15 of furnace chamber 2, and hence avoids exposure of preform 5, fiber 11 being drawn from preform 5 and heating elements 4 to atmospheric gases, meaning thereby avoids oxidation of heating elements and damage of its heating capability, and contamination of preform and fiber being produced therefrom, and hence increase in attenuation loss and deterioration of strength of fiber being drawn from the preform. Therefore, it is highly desirable to have this sealing created by felt 18 intact throughout the drawing process.

The fiber is drawn by any conventional method. It has been observed that when top end 7, provided with handle rod 9, of the preform 5 enters core tube 15 of the furnace chamber 2, a gap 200 is created between felt 18 and top end 7 and/or handle 9 of the preform 5, and a cavity 201 is formed in top portion of the core tube 15 of the furnace chamber 2.

It has been observed that as soon as a gap 200 is created between felt 18 and top end 7 and/or handle 9 of the preform 5 on entry of top end 7 and/or handle 9 of the preform 5 inside core tube 15, the atmospheric gases start entering the core tube 15 as shown by arrows 202, and hence the preform 5, fiber 11 being drawn therefrom and heating elements 4 are exposed to the atmospheric gases which, as described hereinabove, cause oxidation of elements 4 and damage its heating capability, and contamination of preform 5 and fiber 11 being produced therefrom. The contaminated fiber 11 on analysis has been found to have increased attenuation loss, and hence, unsuitable for desired applications with desired performance, and deteriorated strength, and hence, unsuitable for cabling and handling.

It has also been observed that as soon as a cavity 201 is formed between felt 18 and top end 7 and/or handle 9 of preform 5 in top portion of the core tube 15 of furnace chamber 2 on entry of top end 7 and/or handle 9 of the preform 5 inside core tube 15, the inert gases suddenly cause turbulences on and around top end 7 and/or handle 9 of preform 5 as shown by arrows 203, which, as described hereinabove, cause pressure variations inside the core tube 15 of furnace chamber 2 which results in diameter variations of the fiber 11 being drawn which, on analysis, has been observed to have further increased attenuation loss. Additionally, the pressure variations result in curl failure of the fiber 11 being drawn which has been found to be responsible for troubles when a fiber 11 is spliced [joined] to other fibers and loss of overall performance of fiber in optical telecommunication system.

Accordingly, a need arose for having an apparatus for drawing a fiber wherein entry of atmospheric gases due to formation of gap between felt and top end and/or handle of preform inside the core tube of furnace to avoid exposure of preform and fiber being drawn therefrom, and heating elements to the atmospheric gases, and hence above described associated problems thereof, and gas turbulences due to formation of cavity in the top part of core tube of furnace to avoid unexpected change in fiber diameter and its curl failure are avoided to have a fiber having reduced and low attenuation loss suitable for desired applications with desired performance.

It is known to have an apparatus for drawing a fiber wherein a closure 204 is provided on diffuser plate 16. It has been observed that such a closure avoids entry of atmospheric gases inside the core tube of furnace chamber till main body having uniform diameter of preform enters the core tube of furnace chamber. Thereafter, one will have to provide additional closing means. Accordingly, it cannot fully avoid entry of atmospheric gases getting in core tube. Further, the closure 204 does not avoid gas turbulences 203 caused due to formation of cavity 201 between felt 18 and top end 7 and/or handle 9 of preform 5 in top portion of the core tube 15 of furnace chamber 2. Accordingly, an apparatus for drawing a fiber comprising a closure 204 on diffuser plate 16 does not overcome prior art problems as described hereinabove.

The prior art [Japanese patent laid open JP 02-145452] discloses an apparatus for drawing a fiber wherein a hollow glass cap 300 is provided at top end 7 of the preform 5 before it is inserted inside the core tube 15 of furnace chamber 2. It has been observed that hollow glass cap 300 is transparent glass tube 300 forms a seal 400 between felt 18 and glass tube/cap 300 when top end 7 of preform 5 enters core tube 15 of furnace chamber 2, which avoids entry of atmospheric gases inside the core tube 15 of furnace chamber 2 and formation of cavity 201 between felt 18 and top end 7 and/or handle 9 of preform 5 in top portion of the core tube 15 of furnace chamber 2.

Accordingly, it appears that the glass tube/cap 300 is suitable to overcome all disadvantages and drawbacks of the prior art as described hereinabove.

However, it has been observed that during heating of top end 7 of preform 5, felt 18 gets burned out, which in-turn causes formation of gap 500 between burned felt 518 and glass tube/cap 400, which allows free entry of atmospheric gases as shown by arrows 501 in core tube 15, and hence the preform 5, fiber 11 being drawn therefrom and heating elements 4 are exposed to the atmospheric gases which, as described hereinabove, causes oxidation of elements 4 and damages its heating capability, and contamination of preform and fiber being produced therefrom. The contaminated fiber, as described hereinabove, has been found to have increased attenuation loss, and hence, unsuitable for desired applications with desired performance, and deteriorated strength, and hence, unfit for cabling and handling.

Further, a cavity 502, which may be smaller than the cavity formed in an apparatus without glass tube/cap, but is still formed between burned felt 518 and glass tube/cap 300, which results in sudden turbulences on and around top end 7 of preform 5 as shown by arrows 503, which, as described hereinabove, causes pressure variations inside the core tube of furnace which results in diameter variations of the fiber being drawn which, as described hereinabove has been found to have further increased attenuation loss. Additionally, the pressure variations inside the core tube of furnace due to formation of a cavity between burned felt and transparent glass tube result in curl failure of the fiber being drawn which has been found to be responsible for troubles when a fiber is being spliced [joined] to other fibers and loss of overall performance of fiber in optical telecommunication system.

The prior art [Japanese patent laid open JP 2002-356344] attempts to overcome problem of entry of atmospheric gases inside the core tube of furnace chamber, wherein a glass tube/cap is replaced with a cylindrical cap/tube forming a pseudo-preform and provided with a ring like top cover. In accordance with this prior art, a seal between felt and top end and/or handle of preform is formed by cylindrical cap/tube in similar manner as in above discussed prior art [Japanese patent laid open JP 02-145452]. However, in accordance with this prior art, when felt burns out, entry of atmospheric gases inside the core tube of furnace chamber is avoided by a ring like top cover provided on top end of cylindrical cap/tube which closes top opening of cylindrical cap/tube to avoid entry of atmospheric gases on formation of a gap on burning of felt. This prior art further proposes that if, on burning of felt, top cover is not capable of completely avoiding entry of atmospheric gases inside core tube of furnace chamber, then inert gases are supplied at a higher pressure through gas passageway provided at top surface of furnace chamber to maintain positive pressure and inert environment inside the core tube of furnace chamber.

Accordingly, it is understood that even above prior art [Japanese patent laid open JP 2002-356344] also fails to overcome problem of burning of felt, and hence, formation of gap between top end and/or handle portion of preform which has been found to be responsible for allowing free entry of atmospheric gases in core tube of furnace chamber, and therefore, associated problems thereof, and formation of cavity in top part of furnace chamber which has been found to be responsible for causing sudden and unexpected gas turbulences in top part of core tube of furnace chamber, and therefore, associated problems thereof. Therefore, even this prior art does not overcome problems described hereinabove.

The prior art [Japanese patent laid open JP 2003-171139] makes another attempt to overcome problem of entry of atmospheric gases inside the core tube of furnace chamber, wherein gap created at first opening at the top surface of core tube of furnace chamber is sealed by felt by forming a seal between preform and felt in same manner as in conventionally known apparatuses, and a cylindrical cap is provided at top end of preform to cover handle of preform which forms a pseudo-preform as in above discussed prior art [Japanese patent laid open JP 2002-356344]. In accordance with this prior art, the problem of entry of atmospheric gases in core tube of furnace chamber is avoided by forming an additional chamber [aerole] divided by casing formed in the shape of a covering device or a cylinder [which is additional to cylinder cap provided to cover handle of preform] covering felt provided at first opening and covering cylindrical cap forming a pseudo-preform provided at top end of preform to cover handle of preform. The opening of [first] cylindrical cap is sealed with stopper and gap formed between handle of preform and preform insertion port in upper part of additional chamber is sealed with second felt-like seal provided on lower part of said stopper and outside said additional chamber [FIG 1(a) of JP 2003-171139]. In accordance with this prior art, the felt [first seal provided at preform insertion port of furnace chamber] burns down when top portion of preform is processed for fiber draw. At this time, the entry of atmospheric gases inside the core tube of furnace chamber is avoided due to the additional chamber and additional seal provided thereon [para 0037 of JP 2003-171139].

Therefore, it is clear that JP 2003-171139 does overcome problem of entry of atmospheric gases inside the core tube of furnace chamber, but only after providing additional chamber with an additional casing and additional seal, which not only adds to cost of apparatus, but also makes it complicated to be fabricated. Further, an extra care is required to suitably select diameter and height of additional chamber, its casing, location of second seal and first cylindrical cap. Further, this prior art does not overcome problem of formation of cavity in top part of core tube of furnace chamber due to burning of felt.

Accordingly, it is understood that even above prior art [Japanese patent laid open JP 2003-171139] also fails to overcome problem of burning of felt, and hence, formation of gap between top end and/or handle portion of preform which has been found to be responsible for allowing free entry of atmospheric gases in core tube of furnace chamber, and therefore, associated problems thereof, and formation of cavity in top part of furnace chamber which has been found to be responsible for causing sudden and unexpected gas turbulences in top part of core tube of furnace chamber, and therefore, associated problems thereof. Therefore, even this prior art does not overcome problems described hereinabove.

It is also observed that with apparatus of prior art [Japanese patent laid open JP 2003-171139], one cannot draw fiber from complete preform, because at least its portion measuring about 200 mm maintained inside additional chamber cannot be processed for fiber draw. Accordingly, this results in wastage of preform length.

Accordingly, it is understood that none of the prior arts teach any means or method to overcome problem of burning of felt provided on diffuser which causes formation of gap and creation of cavity between felt and top end and/or handle of preform in top portion of core tube of furnace chamber on entry of top end and/or handle of preform inside core tube. The inventors are not aware of any prior art which teaches how to keep the sealing created by felt provided on diffuser intact throughout the drawing process so that not only formation of gap, but also creation of cavity between felt and top end and/or handle of preform in top portion of core tube of furnace chamber on entry of top end and/or handle of preform inside core tube can be completely avoided.

Accordingly, it is clear from the forgoing that prior art cannot completely overcome the problems of:

1. burning of felt provided on diffuser for creating a seal between itself and preform including its top end and handle portion at the preform insertion port in core tube of furnace chamber which is highly desirable throughout the drawing process to avoid entry of atmospheric gases;

2. breakage of seal created by said felt due to its burning during the drawing process;

3. formation of gap between said felt and top end and/or handle of preform in top portion of core tube of furnace chamber on entry of top end and/or handle of preform inside core tube which has been found to be responsible for allowing free entry of atmospheric gases inside the core tube of furnace resulting in exposure of preform and fiber being drawn therefrom, and heating elements to the atmospheric gases, and hence causing oxidation of graphite element and damaging its heating capability, and causing contamination of preform and fiber being produced therefrom, therefore, increase in attenuation loss of fiber being drawn and deterioration of strength of fiber being drawn, therefore, problem in cabling and handling of fiber; and

4. creation of cavity between said felt and top end and/or handle of preform in top portion of core tube of furnace chamber on entry of top end and/or handle of preform inside core tube which has been found to be responsible for causing sudden gas turbulences on and around top end of preform resulting in pressure variations inside the core tube of furnace, and hence causing diameter variations of the fiber being drawn, therefore, further increase in attenuation loss, and causing curl failure of the fiber being drawn, therefore, problems in splicing and loss of overall performance of fiber in optical telecommunication systems.

Accordingly, with the fiber drawing apparatuses known in the art, one cannot completely overcome above-described problems of the prior art and produce a fiber having reduced and low attenuation loss, and good strength so that it is suitable for desired applications with desired performance. Accordingly, it would be an improvement in the art to augment or even replace current techniques with other techniques.

### SUMMARY OF THE INVENTION

There is a need to have an apparatus for drawing an optical fiber having reduced and low attenuation loss, and good strength so that it is suitable for desired applications with desired performance and by overcoming above-described problems of prior art.

Embodiments of the present invention aim at providing such an apparatus for drawing an optical fiber having reduced and low attenuation loss, and good strength so that it is suitable for desired applications with desired performance by overcoming above-described problems of prior art, that is, by avoiding burning of felt provided on diffuser and keeping the sealing created by said felt intact throughout the drawing process so that not only formation of gap, but also creation of cavity between felt and top end and/or handle of preform in top portion of core tube of furnace chamber on entry of top end and/or handle of preform inside core tube can be completely avoided.

Therefore, a main object of embodiments of the present invention is to provide an apparatus and method for drawing an optical fiber having reduced and low attenuation loss, and good strength so that it is suitable for desired applications with desired performance, wherein the apparatus is capable of:

1. avoiding problem of burning of felt provided on diffuser for creating a seal between itself and preform including its top end and handle portion at the preform insertion port in core tube of furnace chamber which is highly desirable throughout the drawing process to avoid entry of atmospheric gases;

2. keeping the sealing created by said felt intact throughout the drawing process;

3. overcoming problem of formation of gap between said felt and top end and/or handle of preform in top portion of core tube of furnace chamber on entry of top end and/or handle of preform inside core tube so as to avoid free entry of atmospheric gases inside the core tube of furnace meaning thereby it is capable of avoiding exposure of preform and fiber being drawn therefrom, and heating elements to the atmospheric gases, and hence capable of avoiding oxidation of graphite element and damage of its heating capability, and contamination of preform and fiber being produced therefrom, therefore, avoiding increase in attenuation loss of fiber being drawn, and deterioration of strength of fiber being drawn, therefore, problem in cabling and handling of fiber with aim to have a fiber having reduced and low attenuation loss, and good strength; and

4. overcoming problem of creation of cavity between said felt and top end and/or handle of preform in top portion of core tube of furnace chamber on entry of top end and/or handle of preform inside core tube so as to avoid sudden gas turbulences on and around top end of preform meaning thereby it is also capable of avoiding pressure variations inside the core tube of furnace, and hence capable of avoiding diameter variations of the fiber being drawn, therefore, avoiding further increase in attenuation loss, and curl failure of the fiber being drawn therefore, problems in splicing and loss of overall performance of fiber in optical telecommunication systems with aim to have a fiber having reduced and low attenuation loss, and good strength.

Accordingly, embodiments of the present invention have an advantage of providing an apparatus and method for drawing an optical fiber having reduced and low attenuation loss, and good strength so that it is suitable for desired applications with desired performance.

Another object of embodiments of the present invention is to provide an apparatus for drawing a fiber wherein no portion of preform is wasted.

Accordingly, embodiments of the present invention have an additional advantage of avoiding wastage of preform length.

Other objects, advantages and preferred embodiments of the present invention will be apparent from the following description when read in conjunction with the accompanying figures, which are not intended to limit scope of the present invention, but are incorporated merely for illustrating the present invention.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates an apparatus for drawing an optical fiber in accordance with prior art;

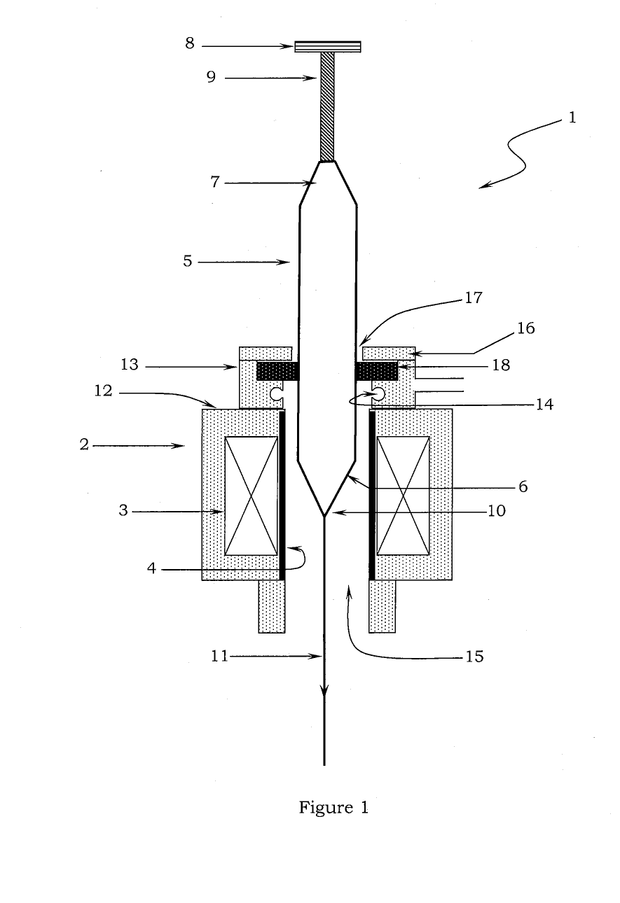

FIG. 2 illustrates an apparatus for drawing an optical fiber in accordance with prior art illustrated in FIG. 1, wherein a closure means is provided;

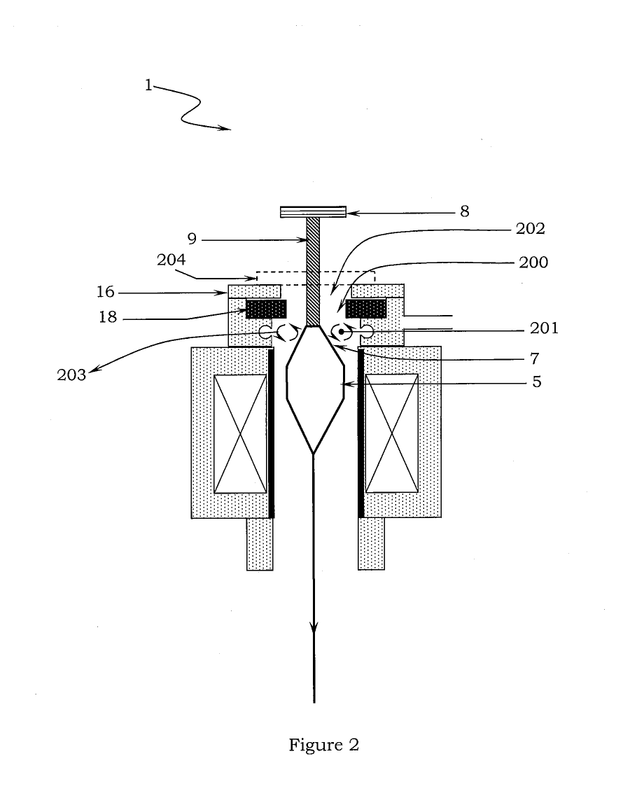

FIG. 3 illustrates an apparatus for drawing an optical fiber in accordance with prior art illustrated in FIG. 1, wherein a glass tube is provided on top end of perform;

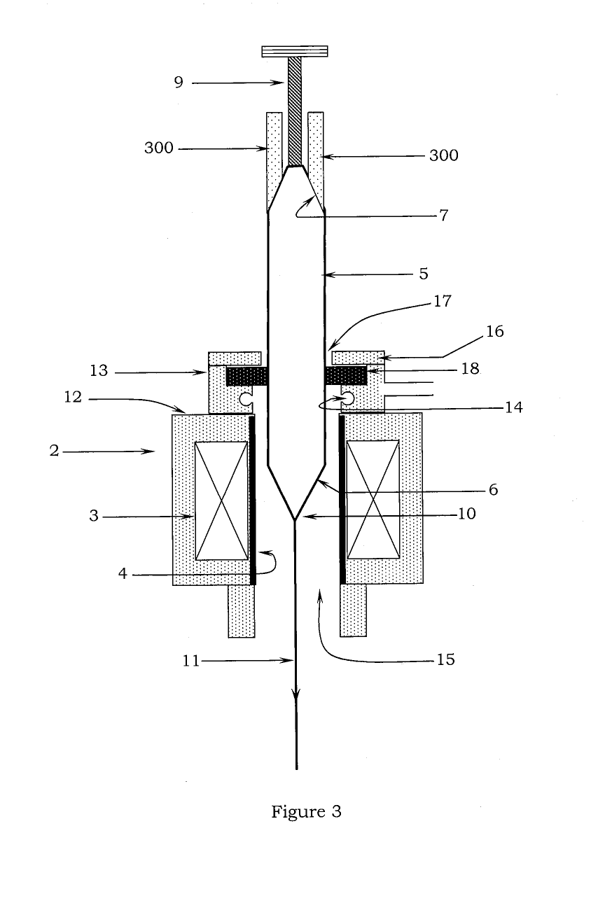

FIG. 4 illustrates an apparatus for drawing an optical fiber in accordance with prior art illustrated in FIG. 3 wherein a glass tube forms seal with felt;

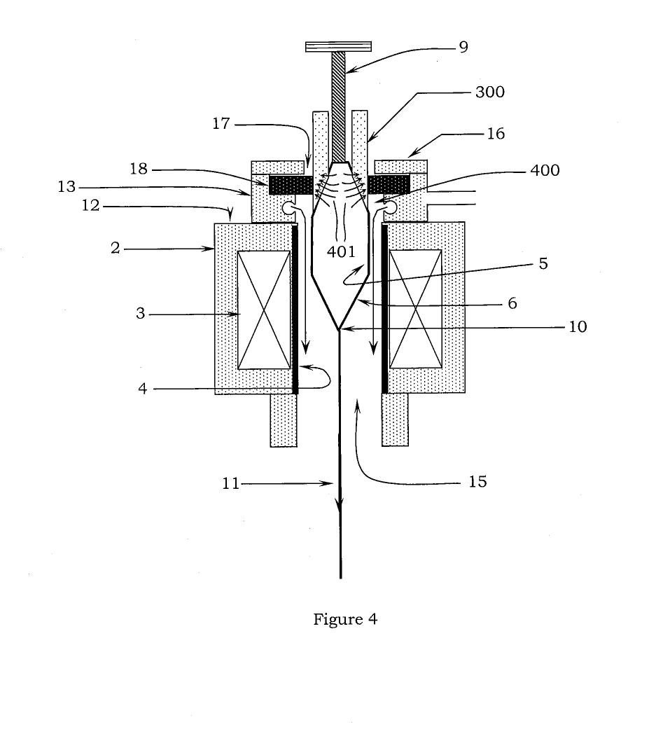

FIG. 5 illustrates an apparatus for drawing an optical fiber in accordance with prior art illustrated in FIG. 3 wherein a gap is formed between felt and glass tube and a cavity is created in top part of core tube of furnace chamber;

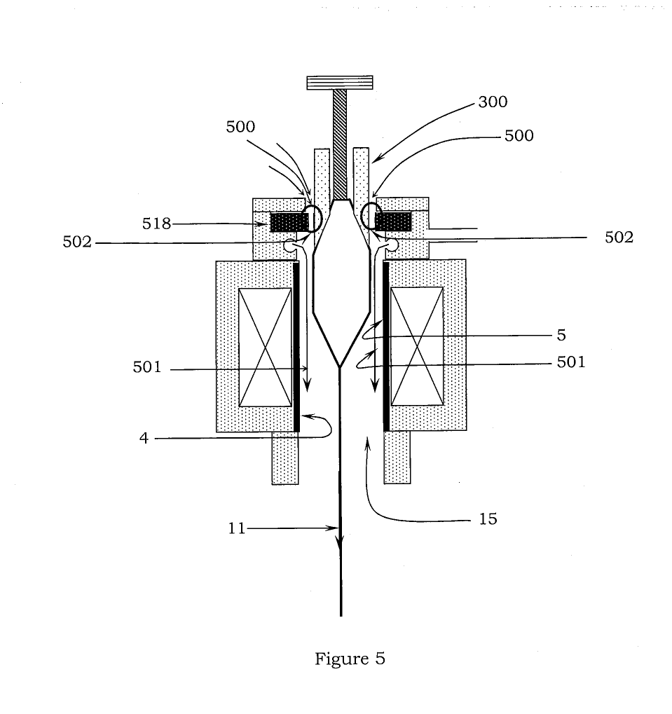

FIG. 6 illustrates an apparatus and method for drawing an optical fiber in accordance with one of the preferred embodiments of the present invention wherein an opaque glass tube is provided on top end of perform;

FIG. 7 illustrates an apparatus and method for drawing an optical fiber in accordance with one of the preferred embodiments of the present invention illustrated in FIG. 6 wherein no gap is formed between felt and glass tube, and no cavity is created in top part of core tube of furnace chamber when majority of preform has been drawn and opaque glass tube has entered the core tube of furnace chamber; and

FIG. 8 illustrates preferred embodiments of opaque glass tube for apparatus for drawing an optical fiber in accordance with a preferred embodiment of the present invention.

### DETAILED DESCRIPTION OF THE INVENTION

It is understood from the foregoing description that to satisfy the stringent requirements of performance of optical fibers in telecommunication systems, the attenuation loss of fiber should be reduced and low, and the fiber should have sufficient strength, and these features of fibers should be controlled and maintained while drawing the fiber. Further, at the same time the heating elements of furnace employed should be protected from oxidation and damages due to exposure to atmospheric gases so as to have longer life and avoid formation of oxidation products which may contaminate the preform and fiber being produced therefrom.

It is also understood from the foregoing description that to have a fiber having reduced and low attenuation loss, and sufficient strength, and also avoiding oxidation and damages of heating elements of furnace, there is a need to avoid burning of felt provided at the diffuser and formation of gap between said felt and top end and/or handle rod of preform so as to avoid entry of atmospheric gases, and creation of cavity in top part of core tube of furnace, or between said felt and top end and/or handle rod of preform so as to avoid occurrences of gas turbulences in top part of core tube of furnace chamber during the entire process of drawing a fiber.

It is apparent form the foregoing description that the apparatuses known in the art do not completely overcome problems described hereinabove, and hence continue to suffer from various problems as described herein.

With aim to overcome problems of prior art described hereinabove, the inventors observed that during heating of top end of preform, surprisingly infrared [IR] radiations pass through glass tube [including glass cap or cylindrical cap] which surprisingly cause burning of felt provided at diffuser which has been confirmed by inventors by observing fumes coming out of lower exit of furnace chamber, and burning of said felt causes formation of gap between said burned felt and said glass tube which allows free entry of atmospheric gases in core tube of furnace chamber and formation of a cavity in top part of core tube of furnace chamber between burned said felt and said glass tube which causes gas turbulences in top part of core tube of furnace chamber. It is clear from the foregoing discussion that under such circumstances the optical fiber preform drawing cannot be continued using the known glass tube 300 even if it is provided with additional chamber and casing because at the end of the optical fiber preform drawing process the said carbon-felt 18 burns out due to the local elevation of temperature at the joint between the handle 9 and the optical fiber preform 5 due to leakage of infrared [IR] radiations through glass tube [or glass cap or cylindrical cap] provided at top end of preform.

Accordingly, the inventors observed that if during heating of preform infrared [IR] radiations passing through glass tube [or glass cap or cylindrical cap] can be stopped the burning of felt provided at diffuser can be avoided meaning thereby formation of gap and creation of cavity can be avoided, and hence problems associated thereto can be avoided.

Accordingly, the present invention relates to an apparatus for drawing an optical fiber having reduced and low attenuation loss, and good strength so that it is suitable for desired applications with desired performance, comprising a furnace comprising a furnace chamber provided with heating means having heating elements, wherein a preform is suitably suspended in core tube of the furnace so that its tip can be suitably heated to a temperature suitable for drawing a fiber, the top face of furnace chamber is provided with a diffuser having an orifice for pumping inert gas into core tube of furnace chamber so as to maintain positive pressure inside the core tube; an opening suitable for insertion of preform; a felt capable of sealing a gap between said preform and said diffuser so as to avoid entry of atmospheric gases in core tube of furnace chamber and allowing preform with variations in its diameter to enter core tube of furnace chamber; a diffuser plate on its top surface with aims for covering said felt from top and minimizing its contact with the atmospheric gases; characterized in that top end of preform is provided with a tubular member which is an opaque glass tube non-permeable to infrared [IR] radiations generated during heating of preform inside the core tube of furnace chamber and capable of stopping passing of IR radiations therethrough to said felt to avoid local elevation of temperature at joint between handle and optical fiber preform so as to avoid burning of felt provided at diffuser, and hence to avoid formation of gap between said felt and said tube, and creation of cavity in top part of said core tube of said furnace chamber.

Accordingly, embodiments of the present invention has a main advantage of avoiding local elevation of temperature at joint between handle and optical fiber preform, and hence, avoiding burning of felt provided at diffuser, which otherwise would have burned out due to leakage of IR radiations through glass tube or glass cap or cylindrical cap provided on top end of preform in conventional apparatuses for drawing a fiber.

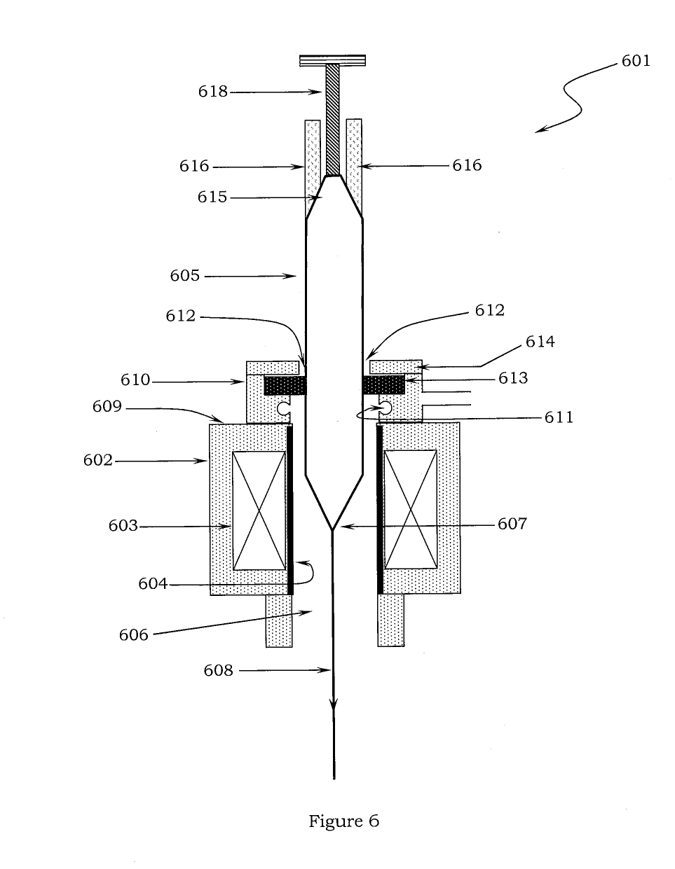

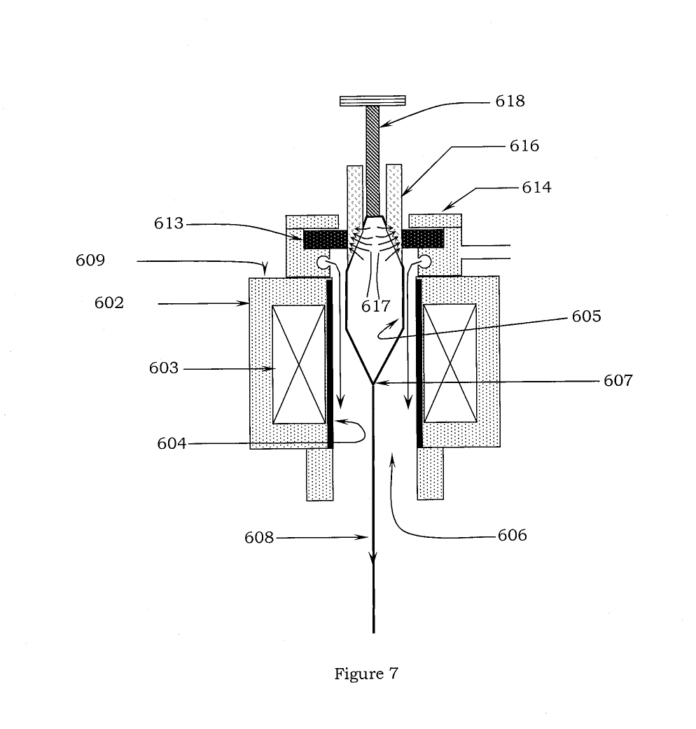

Now referring to accompanying FIGS. 6 and 7, the present invention relates to an apparatus for drawing an optical fiber having reduced and low attenuation loss, and good strength so that it is suitable for desired applications with desired performance, comprising a furnace 601 comprising a furnace chamber 602 provided with heating means 603 having heating elements 604, preferably graphite/carbon elements, wherein a preform 605 is suitably suspended in core tube 606 of the furnace chamber 602 so that its tip 607 can be suitably heated to a temperature suitable for drawing a fiber 608, the top face 609 of furnace chamber 602 is provided with a diffuser 610 having an orifice 611 for pumping inert gas into core tube 606 of furnace chamber 602 so as to maintain positive pressure inside the core tube 606; an opening 612 suitable for insertion of preform 605; a felt 613 capable of sealing a gap [an opening] 612 between said preform 605 and said diffuser 610 so as to avoid entry of atmospheric gases in core tube 606 of furnace chamber 602 and allowing preform 606 with variations in its diameter to enter core tube 606 of furnace chamber 602; a diffuser plate 614 on its top surface with aims for covering said felt 613 from top and minimizing its contact with the atmospheric gases; characterized in that top end 615 of preform 605 is provided with a tubular member 616 which is an opaque glass tube non-permeable to infrared [IR] radiations 617 [FIG. 7] generated during heating of preform 605 inside the core tube 606 of furnace chamber 602, and is capable of stopping passing of infrared [IR] radiations 617 [FIG. 7] therethrough to said felt 613 to avoid local elevation of temperature at joint between handle 618 and optical fiber preform 605 so as to avoid burning of felt 613 provided at diffuser 610, and hence formation of gap between said felt 613 and said tube 616, and creation of cavity in top part of said core tube 606 of said furnace chamber 602.

The accompanying FIG. 7 clearly illustrates that the infrared [IR] radiations shown by arrows 617 generated during heating of preform 605 inside the core tube 606 of furnace chamber 602 do not pass onto felt 613 as indicated by “crossed” arrows 617. Accordingly, the present invention has advantage of stopping passing of infrared [IR] radiations 617 through the tube 616 provided in presently disclosed apparatus to said felt 613 meaning thereby has advantages of avoiding burning of said felt 613 provided at said diffuser 610, and formation of gap between said felt 613 and said tube 616, and creation of cavity in top part of said core tube 606 of said furnace chamber 602.

Accordingly, it is clear from the foregoing description and accompanying FIGS. 6 and 7 which are not intended to limit scope of present invention that when a fiber is drawn by employing presently disclosed apparatus comprising opaque glass tube 616 non-permeable to infrared [IR] radiations 617 which is provided at top end 615 of preform 605 then neither felt 613 provided at top surface of diffuser 610 bums which has been confirmed by no fumes coming out of lower exit of furnace chamber nor any gap is formed between felt 613 and opaque tube 616 provided in apparatus of present invention which has been confirmed by no oxidation of heating elements which otherwise would have oxidized due to exposure to atmospheric gases which would have entered the core tube had a gap been formed nor any cavity is formed in top part of core tube 606 which has been confirmed by no variations of diameter and good strength of fiber drawn from preform which otherwise would been caused and strength would have been lost due to pressure variations caused due to gas turbulences had a cavity been formed in top portion of core tube of furnace chamber of apparatus of present invention.

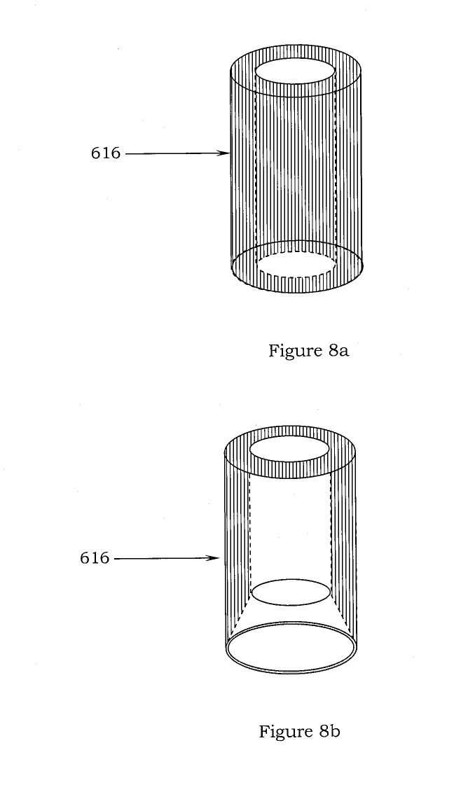

The tubular member which is opaque glass tube non-permeable to IR radiations is a cylindrical member having outer diameter corresponding to preform diameter and inner diameter corresponding to diameter of preform handle so that it can be placed concentrically on the top end of preform in such a manner that it covers preform handle. In one embodiment it is cylindrical tube [FIG. 8a]. In one embodiment it is cylindrical tube having one conical end corresponding to conical top end of preform [FIG. 8b].

Accordingly, the present invention provides an apparatus and method for drawing an optical fiber having reduced and low attenuation loss, and good strength, wherein the apparatus and method are capable of:

1. avoiding problem of burning of felt provided on diffuser for creating a seal between itself and preform including its top end and handle portion at the preform insertion port in core tube of furnace chamber which is highly desirable throughout the drawing process to avoid entry of atmospheric gases;

2. keeping the sealing created by said felt intact throughout the drawing process;

3. overcoming problem of formation of gap between said felt and top end of preform in top portion of core tube of furnace chamber on entry of top end of preform inside core tube, and between said felt and handle of preform in top portion of core tube of furnace chamber on entry of handle of preform inside core tube so as to avoid free entry of atmospheric gases inside the core tube of furnace meaning thereby it is capable of avoiding exposure of preform and fiber being drawn therefrom, and heating elements to the atmospheric gases, and hence capable of avoiding oxidation of graphite element and damage of its heating capability, and contamination of preform and fiber being produced therefrom, therefore, avoiding increase in attenuation loss of fiber being drawn, and deterioration of strength of fiber being drawn, therefore, problem in cabling and handling of fiber with aim to have a fiber having reduced and low attenuation loss, and good strength; and

4. overcoming problem of creation of cavity between said felt and top end of preform in top portion of core tube of furnace chamber on entry of top end of preform inside core tube, and between said felt and handle of preform in top portion of core tube of furnace chamber on entry of handle of preform inside core tube so as to avoid sudden gas turbulences on and around top end of preform meaning thereby it is also capable of avoiding pressure variations inside the core tube of furnace, and hence capable of avoiding diameter variations of the fiber being drawn, therefore, avoiding further increase in attenuation loss, and curl failure of the fiber being drawn therefore, problems in splicing and loss of overall performance of fiber in optical telecommunication systems with aim to have a fiber having reduced and low attenuation loss, and good strength.

In one embodiment, the present invention relates to use of an opaque glass tube in an optical fiber draw apparatus wherein the opaque glass tube is non-permeable to infrared [IR] radiations generated during heating of preform inside the core tube of furnace chamber of optical fiber draw apparatus.

In one embodiment, the present invention relates to an apparatus for drawing a fiber wherein leakage of IR radiations through tubular member provided on top end of preform is avoided by providing a tubular member at top end of preform which is opaque glass tube non-permeable to IR radiations generated during heating of preform inside the core tube of furnace chamber of optical fiber draw apparatus.

In one embodiment, the present invention relates to an apparatus for drawing a fiber wherein local elevation of temperature at joint between preform handle and preform is avoided by providing a tubular member at top end of preform which is opaque glass tube non-permeable to IR radiations generated during heating of preform inside the core tube of furnace chamber of optical fiber draw apparatus.

In one embodiment, the present invention relates to an apparatus for drawing a fiber wherein burning of felt provided at diffuser is avoided by providing a tubular member at top end of preform which is opaque glass tube non-permeable to IR radiations generated during heating of preform inside the core tube of furnace chamber of optical fiber draw apparatus.

In one embodiment, the present invention relates to an apparatus for drawing a fiber wherein formation of gap between felt and tubular member provided on top end of preform is avoided by providing a tubular member at top end of preform which is opaque glass tube non-permeable to IR radiations generated during heating of preform inside the core tube of furnace chamber of optical fiber draw apparatus.

In one embodiment, the present invention relates to an apparatus for drawing a fiber wherein creation of cavity in top part of core tube of furnace chamber is avoided by providing a tubular member at top end of preform which is opaque glass tube non-permeable to IR radiations generated during heating of preform inside the core tube of furnace chamber of optical fiber draw apparatus.

In one embodiment, the present invention relates to an apparatus for drawing a fiber wherein oxidation of heating elements, and exposure of preform and fiber being drawn therefrom to oxidized products produced on oxidation of heating elements are avoided by providing a tubular member at top end of preform which is opaque glass tube non-permeable to IR radiations generated during heating of preform inside the core tube of furnace chamber of optical fiber draw apparatus.

Accordingly, the present invention has advantage of providing an apparatus and method for drawing an optical fiber having reduced and low attenuation loss, and good strength so that it is suitable for desired applications with desired performance.

Therefore, in one embodiment, the present invention also relates to optical fiber having reduced and low attenuation loss, and good strength and being suitable for desired applications with desired performance.

In accordance with present invention, the preform 605 can be completely inserted inside the core tube 606 for its complete processing to completely draw fiber 608 therefrom, and hence has additional advantage of avoiding wastage of preform length.

In accordance with present invention, the opaque tube provided on top end of preform covers handle of preform so that when handle portion of preform enters inside core tube of furnace chamber no gap is formed and no cavity is created.

In accordance with preferred embodiment of the present invention, the felt is made from suitable heat resistant material which is flexible in nature so as to allow complete sealing with opaque glass tube provided in present invention. Preferably, the felt is graphite/carbon fiber felt.

In accordance with preferred embodiment of the present invention, the opaque glass tube is of same diameter as of preform so that no gap is formed when top end of preform provided with opaque glass tube enters the core tube of furnace chamber.

It may be noted that in accordance with present invention, the felt is made from a flexible material, therefore, the gap if any created due to minor mis-match of diameters of opaque glass tube and preform can be easily sealed by felt.

In one embodiment, the present invention also relates to a method for drawing an optical fiber by employing an apparatus for drawing an optical fiber provided in accordance with present invention.

The present invention is now described with reference to the following examples, which are not intended to limit the scope of this invention.

### EXAMPLE 1

### Prior Art

A glass handle of diameter 20 mm as known in art was heat welded to one end of preform of diameter 90 mm and length 70 cm. The assembly of glass handle-optical fiber preform was transferred to the conventional optical fiber drawing furnace and suspended in its core tube by a suspending means. Before suspending the assembly of glass handle-optical fiber preform, a cylindrical tubular member having outer diameter of 90 mm, thickness of 10 mm and height of 20 cm as known in art was positioned on top end of optical fiber preform. Once complete assembly comprising preform, handle and cylindrical member is properly suspended in core tube of furnace, preform heated to a temperature of 2000° C. and fiber drawing is started from bottom end of fiber drawing furnace. A non-contact temperature measuring laser device was used to measure temperature on marked point on surface of cylindrical tubular member from beginning to end of fiber drawing process. The temperature on surface of cylindrical tubular member was measured at regular intervals of length of preform (see Table 1) and it was found (as can see from Table 1) that there was no significant increase in the temperature on surface of cylindrical tubular member at beginning till more than half of preform was drawn. Thereafter, the temperature on surface of cylindrical tubular member suddenly began to increase and increased faster when approximately 50 cm of the preform was left for drawing. At this time, the temperature on surface of cylindrical tubular member as measured by non-contact temperature measuring laser device was found to be as high as 225° C. Thereafter, with drawing of fiber, the temperature on surface of cylindrical tubular member continued to increase and increased much faster when approximately 40 cm of the preform was left for drawing. The increase in temperature on surface of cylindrical tubular member continued further till approximately 20 cm of the preform was left for drawing. At this stage, the temperature on surface of cylindrical tubular member as measured by non-contact temperature measuring laser device was found to be 395° C. which was found to be 220° C. higher than the temperature on surface of cylindrical tubular member when preform length was 70 Cm with temperature on surface of cylindrical tubular member found to be 175° C. When preform length of about 30 Cm was left, fumes were also observed from lower end of furnace chamber confirming oxidation of heating elements, and hence, burning of felt provided on diffuser and formation of gap between felt and cylindrical tubular member which allowed free entry of atmospheric gases inside the core tube of furnace chamber, and hence, exposure of felt and heating elements to atmospheric gases. When preform length of about 20 Cm was left, the fiber drawing was also discontinued resulting in wastage of 20 Cm length of preform.

TABLE 1

| | | Temperature on |
|---|---|---|
| | Optical fiber | the surface of the |
| | preform length | member 3 |
| Sr. No. | (cm) | (degree Celsius) |
| 1 | 70 | 175 |
| 2 | 60 | 190 |
| 3 | 50 | 225 |
| 4 | 40 | 300 |
| 5 | 30 | 355 |
| 6 | 20 | 395 |

The fiber drawn was analyzed for its strength and attenuation loss. The optical fiber drawn from preform after its length of 40 Cm was found to have low strength and increased attenuation loss which was found to be 0.345 dB/Km at 1310 nm and 0.220 dB/Km at 1550 nm as measured by optical time domain reflectometer PK 6500 which is very high for its suitability for desired applications. The fiber curl as measured by using curl measuring instrument PK 2411 from photon kinetics which gives radius of curvature of fiber bend was found to be value less than 4 m which should have been greater than 4 m for ease of splicing. Further, the fiber diameter variation as measured during the fiber drawing process itself by using optical fiber diameter measuring instrument commercially available under the name of Beta Laser Mike was found to be 125±0.9 micron in the fiber drawn from preform having 40 Cm to 20 Cm length. Accordingly, the fiber drawn from the preform having 40 Cm or lower length was discarded.

Further, the high-grade carbon felt and high-grade carbon heating elements were also discarded because the same were burned out and oxidized and were replaced with new felt and elements resulting in overall wastage of production time and increase of production cost.

Accordingly, the increase in temperature at a point marked on surface of cylindrical tubular member confirmed that heat dissipation took place through the cylindrical tubular member resulting in heating of felt causing its burning which was indicated by fumes from lower end of furnace chamber which were formed due to oxidation of heating elements which in-turn took place due to free entry of atmospheric gases due to burning of felt and formation of gap between burned felt and cylindrical tubular member. Further, poor strength, increased attenuation loss and diameter variations of fiber drawn after 40 Cm of prefrom length also confirmed burning of felt, and formation of gap between felt and cylindrical tubular member, and formation of cavity in top part of core tube of furnace chamber.

### EXAMPLE 2

### Embodiment of the Present Invention

A glass handle of diameter 20 mm as known in art was heat welded to one end of preform of diameter 90 mm and length 70 cm. The assembly of glass handle-optical fiber preform was transferred to the optical fiber drawing furnace of present invention and suspended in its core tube by a suspending means. Before suspending the assembly of glass handle-optical fiber preform, an opaque glass tube non-permeable to IR radiations having outer diameter of 90 mm, thickness of 10 mm and height of 20 cm of the present invention was positioned on top end of optical fiber preform. Once complete assembly comprising preform, handle and opaque glass tube non-permeable to IR radiations is properly suspended in core tube of furnace, preform heated to a temperature of 2000° C. and fiber drawing is started from bottom end of fiber drawing furnace. A non-contact temperature measuring laser device was used to measure temperature on marked point on surface of opaque glass tube non-permeable to IR radiations from beginning to end of fiber drawing process.

The temperature on surface of opaque glass tube non-permeable to IR radiations was measured at regular intervals of length of preform (see Table 2) and it was surprisingly found (as can see from Table 2) that there was no significant increase in temperature on surface of opaque glass tube non-permeable to IR radiations from beginning till end of preform length. At the point of fiber draw when preform length was 70 Cm, the temperature on surface of opaque glass tube non-permeable to IR radiations as measured by non-contact temperature measuring laser device was found to be as low as 170° C., and at the point of fiber draw when preform length was 20 Cm, the temperature on surface of opaque glass tube non-permeable to IR radiations was found to be as low as 187° C. The temperature on surface when preform length remained 2 Cm could not be measured, because the entire preform and opaque glass tube of present invention entered inside the core tube of furnace chamber.

No fumes were observed from lower end of furnace chamber confirming no oxidation of heating elements, and hence, no burning of felt provided on diffuser and no formation of gap between felt and cylindrical tubular member, accordingly, no free entry of atmospheric gases inside the core tube of furnace chamber, and hence, no exposure of felt and heating elements to atmospheric gases. Further, with fiber drawing apparatus of present invention, the fiber drawing was continued till the preform was completely drawn resulting in total utilization of preform length.

TABLE 2

| | | Temperature on |
|---|---|---|
| | Optical fiber | the surface of the |
| | preform length | member 3 |
| Sr. No. | (cm) | (degree Celsius) |
| 1 | 73 | 170 |
| 2 | 60 | 178 |
| 3 | 50 | 180 |
| 4 | 40 | 183 |
| 5 | 30 | 185 |
| 6 | 20 | 187 |

The fiber drawn was analyzed for its strength and attenuation loss. The optical fiber drawn from preform including its length between 40 Cm to 2 Cm was found to have higher strength and reduced and low attenuation loss which was found to be 0.321 dB/Km at 1310 nm and 0.195 dB/Km at 1550 nm as measured by optical time domain reflectometer PK 6500 which is very low for its suitability for desired applications. The fiber curl as measured by using curl measuring instrument PK 2411 from photon kinetics was found to be value greater than 4 m for ease of splicing. Further, the fiber diameter variation as measured during the fiber drawing process itself by using optical fiber diameter measuring instrument commercially available under the name of Beta Laser Mike was found to be 125±0.5 micron in the fiber drawn from preform including its length between 40 Cm or lower. Accordingly, none of the part of fiber drawn from the preform over its entire length was discarded and fiber could be drawn from entire length of preform.

Further, the high-grade carbon felt and high-grade carbon heating elements were not discarded because the same did not burned out and oxidized, and hence, were not replaced with new felt and elements resulting in overall savings of production time and production cost.

Accordingly, the temperature at a point marked on surface of opaque glass tube non-permeable to IR radiations employed in present invention did not show any substantial increase confirming that heat dissipation did not took place through the opaque glass tube non-permeable to IR radiations employed in present invention, and hence, no heating of felt, no burning of felt, no fumes from lower end of furnace chamber were observed confirming no oxidation of heating elements, no entry of atmospheric gases, no formation of gap between burned felt and opaque glass tube non-permeable to IR radiations employed in present invention. Further, increased strength, and reduced and low attenuation loss, and no substantial diameter variations, and increased value of radius of curvature (greater than 4 m), and hence, decreased value of curl of fiber drawn over entire prefrom length also confirmed no burning of felt, and no formation of gap between felt and opaque glass tube non-permeable to IR radiations employed in present invention, and no formation of cavity in top part of core tube of furnace chamber.

Thus, it is concluded from the above two examples that use of opaque glass tube non-permeable to IR radiations in accordance with embodiments of the present invention does completely overcome all problems of prior art described hereinbefore which have been achieved even without providing additional chamber with an additional casing and additional seal. Further, no extra care was required to suitably select diameter and height of any additional chamber, its casing, location of second seal, because the same have been totally eliminated in present invention. Further, no extra care was required for selecting diameter and length of opaque glass tube non-permeable to IR radiations employed in present invention, the inner diameter of which should be suitable to accommodate preform handle and outer diameter of which should be suitable to correspond to preform diameter. Further, the fiber could be completely drawn from preform till its entire length, and hence there is no wastage of preform length. Accordingly, the present fiber drawing furnace has been found to be economical and convenient to be fabricated.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An apparatus for drawing an optical fiber having reduced and low attenuation loss, and good strength which is suitable for desired applications with desired performance, comprising a furnace comprising a furnace chamber provided with heating means having heating elements, wherein a preform is suitably suspended in core tube of the furnace so that its tip can be suitably heated to a temperature suitable for drawing a fiber, the top face of furnace chamber is provided with a diffuser having an orifice for pumping inert gas into core tube of furnace chamber so as to maintain positive pressure inside the core tube; an opening suitable for insertion of preform; a felt capable of sealing a gap between said preform and said diffuser so as to avoid entry of atmospheric gases in core tube of furnace chamber and allowing preform with variations in its diameter to enter core tube of furnace chamber; a diffuser plate on its top surface with aims for covering said felt from top and minimizing its contact with the atmospheric gases; characterized in that top end of preform is provided with a tubular member which is an opaque glass tube non-permeable to infrared [IR] radiations generated during heating of preform inside the core tube of furnace chamber and capable of stopping passing of IR radiations therethrough to said felt to avoid local elevation of temperature at joint between handle and optical fiber preform so as to avoid burning of felt provided at diffuser, and hence to avoid formation of gap between said felt and said tube, and creation of cavity in top part of said core tube of said furnace chamber.

2. An apparatus as claimed in claim 1, wherein said opaque glass tube is suitable to cover handle of preform.

3. An apparatus as claimed in claim 1, wherein said felt is made from suitable heat resistant material which is flexible in nature so as to allow complete sealing with said opaque glass tube.

4. An apparatus as claimed in claim 3, wherein said opaque glass tube is cylindrical in shape having one conical end corresponding to conical top end of preform.

5. An apparatus for drawing an optical fiber having reduced and low attenuation loss, and good strength, wherein apparatus is capable of:
a) avoiding problem of burning of felt provided on diffuser for creating a seal between itself and preform including its top end and handle portion at the preform insertion port in core tube of furnace chamber;
b) keeping the sealing created by said felt intact throughout the drawing process;
c) overcoming problem of formation of gap between said felt and top end of preform in top portion of core tube of furnace chamber on entry of top end of preform inside core tube, and between said felt and handle of preform in top portion of core tube of furnace chamber on entry of handle of preform inside core tube so as to avoid free entry of atmospheric gases inside the core tube of furnace in order to avoid exposure of preform and fiber being drawn therefrom, and heating elements to the atmospheric gases; and
d) overcoming problem of creation of cavity between said felt and top end of preform in top portion of core tube of furnace chamber on entry of top end of preform inside core tube, and between said felt and handle of preform in top portion of core tube of furnace chamber on entry of handle of preform inside core tube so as to avoid sudden gas turbulences on and around top end of preform in order to avoid pressure variations inside the core tube of furnace.

6. An apparatus as claimed in claim 1, wherein leakage of IR radiations through tubular member provided on top end of preform is avoided by providing opaque glass tube non-permeable to IR radiations at top end of preform.

7. An apparatus as claimed in claim 1, wherein local elevation of temperature at joint between preform handle and preform is avoided by providing opaque glass tube non-permeable to IR radiations at top end of preform.

8. An apparatus as claimed in claim 1, wherein burning of felt provided at diffuser is avoided by providing opaque glass tube non-permeable to IR radiations at top end of preform.

9. An apparatus as claimed in claim 1, wherein formation of gap between felt and tubular member provided on top end of preform is avoided by providing opaque glass tube non-permeable to IR radiations at top end of preform.

10. An apparatus as claimed in claim 1, wherein creation of cavity in top part of said core tube of said furnace chamber is avoided by providing opaque glass tube non-permeable to IR radiations at top end of preform.

11. An apparatus as claimed in claim 1, wherein oxidation of heating elements, and exposure of preform and fiber being drawn therefrom to oxidized products produced on oxidation of heating elements are avoided by providing opaque glass tube non-permeable to IR radiations at top end of preform.

12. Use of opaque glass tube non-permeable to IR radiations in apparatus for drawing an optical fiber.

13. An optical fiber having reduced and low attenuation loss, and good strength and being suitable for desired applications with desired performance.

14. A method for drawing an optical fiber by employing an apparatus for drawing an optical fiber as claimed in claim 1.

15. An apparatus as claimed in claim 5, wherein leakage of IR radiations through tubular member provided on top end of preform is avoided by providing opaque glass tube non-permeable to IR radiations at top end of preform.

16. An apparatus as claimed in claim 5, wherein local elevation of temperature at joint between preform handle and preform is avoided by providing opaque glass tube non-permeable to IR radiations at top end of preform.

17. An apparatus as claimed in claim 5, wherein burning of felt provided at diffuser is avoided by providing opaque glass tube non-permeable to IR radiations at top end of preform.

18. An apparatus as claimed in claim 5, wherein formation of gap between felt and tubular member provided on top end of preform is avoided by providing opaque glass tube non-permeable to IR radiations at top end of preform.

19. An apparatus as claimed in claim 5, wherein creation of cavity in top part of said core tube of said furnace chamber is avoided by providing opaque glass tube non-permeable to IR radiations at top end of preform.

20. An apparatus as claimed in claim 5, wherein oxidation of heating elements, and exposure of preform and fiber being drawn therefrom to oxidized products produced on oxidation of heating elements are avoided by providing opaque glass tube non-permeable to IR radiations at top end of preform.

21. A method for drawing an optical fiber by employing an apparatus for drawing an optical fiber as claimed in claim 5.
